(19) United States
(12) Patent Application Publication
(10) Pub. No.: US 2004/0080194 A1
(43) Pub. Date: Apr. 29, 2004

(54) Mechanical attachment of anchorage

(75) Inventors: Jeffry P. Medvecky, Brighton, MI (US); Todd R. Muck, Fowlerville, MI (US); Matthew C. McClelland, Trenton, MI (US); Eric S. Hansen, Livonia, MI (US); Russell R. Burns, Westland, MI (US); Joseph M. Kish, Brownstown, MI (US); Grant A. Adams, Livonia, MI (US); Edward J. Lamont, Livonia, MI (US); Omar H. Khatib, Dearborn Heights, MI (US); Ioan J. Neaga, Farmington Hills, MI (US); Xin Liu, Novi, MI (US); Ashok K. Sethi, Ann Arbor, MI (US)

Correspondence Address: FOLEY & LARDNER, 150 WEST JEFFERSON AVENUE, SUITE 1000, DETROIT, MI, 48226-4443, US

(73) Assignee: Johnson Controls Technology Company

(21) Appl. No.: 10/281,521

(22) Filed: Oct. 28, 2002

(51) Int. Cl. B60N 2/28

(52) U.S. Cl. 297/253

(57) ABSTRACT

A child safety seat anchorage is mechanically attached and welded to a robust support member, e.g., a tube or bracket, which in turn is secured to a vehicle seat or the vehicle frame. The welding of the wire rod is primarily for the purpose of positioning the wire rod at the prescribed location within a vehicle so that hooks, straps or other connectors from a child safety seat can be attached to the wire rod anchorage. The anchorage is located at and extends from a bite line between a seat cushion and a seat back. Alternative attachment designs include the use of a strap, alternative design wire rod anchorages and slots and holes to connect the wire rod anchorage to the tube or bracket.

### CROSS REFERENCE TO RELATED APPLICATIONS

The present application is related to the application titled Retainer and Wire Rod for Child Safety Seat Anchorage, to Tong, et al., filed ______; and to the application titled Mechanical Attachment of Anchorage and Bracket, to Adams, et al., filed ______, which are incorporated herein by reference.

### FIELD OF THE INVENTION

The present invention relates generally to the field of securely anchoring an article, such as an infant, child or toddler vehicle carrier or seat, to a vehicle seat. More particularly the present invention relates to a robust way of attaching an anchorage to the vehicle. Still more specifically, the invention relates to a mechanical coupling for connecting an anchorage to the vehicle seat or to the vehicle frame.

### BACKGROUND OF THE INVENTION

Anchoring various articles to vehicle seats is becoming increasingly important as new products, rules, regulations and laws begin to transform prior practices. For example, until recently seats to be installed in a vehicle seat (hereinafter referred to as “child safety seats”) for infants, toddlers and small children were held in place using the available shoulder and lap belt which were, of course, designed for protection of much larger passengers. While the shoulder and lap belt adequately secured the infant seat to the vehicle seat, due to design variations from vehicle to vehicle and from child safety seat to child safety seat, the efficacy of such systems were subject to the user's ability to properly install the infant seat.

Some modifications and standardization were incorporated into child safety seats such as providing belt notches to guide the factory installed belts across the child, and even as of the filing date of this specification, law enforcement personnel, child safety seat manufacturers, vehicle manufacturers and sellers, and various safety advocates are trying to inform parents and other child care givers about the best ways to attach child safety seats and snug or tighten them into compressive engagement with the vehicle seat's seat cushion and seat back.

In addition to child safety seats, it is also desirable to be able to securely attach other articles and devices to vehicle seats, e.g., play or activity centers, auto office products, and entertainment centers (such as those which employ VHS, DVD or CD input to a monitor or screen). While passengers do not occupy the space consumed by such products, it is important to ensure that such articles do not come loose and injure passengers, e.g., in the event of a severe impact.

In numerous foreign countries (e.g., Australia and Canada), and recently in the United States, a new system for child safety seat attachment has been developed and mandated for use. This system is known in the United States as L.A.T.C.H. (Lower Anchors and Tethers for Children) The system involves providing anchorage at the bite line of a vehicle seat (i.e., the area between the seat cushion and the seat back) to which straps, belts or a linkage from a child safety seat are attached. The Federal Motor Vehicle Safety Standards relating to Crash Worthiness as set forth in 49 C.F.R. Parts 571 and 596, which are incorporated herein by reference, require a pair of wire rod anchorage to be spaced apart from one another by a specific distance, and in use a child safety seat is placed on the seat cushion between them. In particular, it is required that the child safety seat anchorages be standardized and independent of the vehicle seat belts. Two straps secured to the child safety seat (or a single strap passing through the child safety seat) have hooks or other connectors attached to their free ends. The hooks are placed over the wire rods, and slack is taken out of the straps using length adjustment devices which, in and of themselves, are of the types used with passenger lap belts. The child safety seat is then held in place by a system which ultimately depends on the robustness of wire rods.

It can also be mentioned here that a third point of anchoring the child safety seat is also being required, namely a package shelf anchorage (for the rear seat of a vehicle which has a package shelf) or a third anchorage at the base of the back of a seat (such as captain, bucket, or bench seats in a sport utility vehicle, van and the like). The latter allows a third strap or tether attached to the top of a child safety seat to be secured to this third anchorage to assist in preventing forward tilting of the child safety seat in the event of an impact. The applicability of the present invention to such third anchorages will become apparent to those skilled in the art as the description of the background and the preferred and alternate embodiments of the invention continue.

The number of ways in which the wire rods used in the aforementioned system are construed varies widely, due to the style of seat and vehicle, and the available seat frame or vehicle frame locations for attachment of the wire rods are numerous. In most cases, however, the wire rods are attached by welding them to a seat frame or vehicle frame component such as a tube connected to the seat. The type of connection may also depend upon the type of seat that the anchorage is being connected such as a bench seat, a captain's chair or other alternative seat. Therefore, the robustness of the load bearing performance of the wire rod anchorage is dependent on many factors including the wire rod material, geometry, weld materials, weld design and workmanship, and many events subsequent to wire rod installation which could affect the integrity of the welds.

Several examples exist which demonstrate types and designs of connections for attaching a wire rod anchorage to a vehicle seat. For example, U.S. Pat. Nos. 6,354,648; 6,196,628; 6,030,046; 5,941,601; 5,918,934; 5,816,651; 6,361,115; 6390,560; and 6,276,754 all disclose a variety of designs for attaching an anchorage to a vehicle seat and all of which have significant drawbacks in that they either require the wire rod anchorage be directly welded to another seat device or they require a manufacturing process that is overly complex and costly.

It would be highly desirable in this art to use a system for installing the wire rod anchors which substantially eliminates the potential failure based on a weld between the wire rod and another component due to problems with materials, design or workmanship. The benefit to the art would be further enhanced if any such system could be readily adapted to a wide variety of seat types and styles having a similar variety of support mechanisms and frame attachment configurations.

### SUMMARY OF THE INVENTION

One feature of the present invention relates to providing a technique for attaching wire rod anchorages to a vehicle's seat or vehicle frame components which relies primarily on mechanical coupling rather than welding to transfer impact loads.

Another feature of the present invention is to provide a technique for mechanically coupling wire rod anchorages to tubes and/or brackets of a vehicle or vehicle seat which may be readily adapted to a wide variety of vehicles and vehicle seat styles.

A further feature of the present invention is to provide wire rod anchorages having improved reliability.

A different feature of the present invention is to provide a method for coupling wire rod anchorages to tubes and/or brackets of a vehicle or a vehicle seat which reduces assembly time and cost.

A still further feature of the present invention is to provide wire rod anchorages having improved load transfer in the event of sudden change in acceleration from an unintended event such as an impact from an accident.

Generally, however, they are accomplished by mechanically coupling the wire rods to tubes or brackets which form part of a vehicle seat or the vehicle frame. Welds may be employed, especially for ensuring a proper location of the anchorages relative to the seat, but with the mechanical coupling system of the present invention, the welds have a limited function in transferring loads from the child safety seat (or other device) coupling to the load bearing structure of the seat or vehicle frame.

In one embodiment of the present invention, a wire rod is generally U-shaped and includes outwardly curled ends on the leg portions of the “U.” The wire rod passes through a pair of opposed slots in a round tube so that the curved “U” shaped portion of the rod extends to the proper seat bite location and so that the curled ends enter a pair of holes in one side of the tube located adjacent each end of one of the slots. In a variant of this embodiment, the legs of the “U” are shorter and pair of receiving holes is located on the side of the tube from which the wire rod extends and a close-out bracket covers the slot through which the wire rod passes during assembly of holes and the curled ends are forced toward one another so that they fit within the slot and then spring outwardly so that the ends can be inserted into the holes. In either variant, one or a plurality of welds can be provided to hold the wire rod in its “in use” location. Moreover, one or more channel brackets can be provided around the exposed legs of the U-shaped wire rods to resist bending of the legs of the U-shaped components.

In another embodiment of the present invention, U-shaped wire rods with inwardly curled ends on the legs are coupled to a bracket element which is stamped or otherwise formed to include a pair of elongate, spaced-apart recesses on either side of a raised portion. The recess extends about the bottom of the raised portion and an opening into the raised portion is provided to receive the ends of the legs. The wire rods are bent with respect to the plane of the raised portion so that any load placed on the wire rod is transferred to the bracket. Again, welds and channels can be added for positioning and anti-bending purposes.

In another alternate embodiment of the invention, the legs of the wire rod pass through aligned openings in a tube, with the location of the holes and bends in the wire rods being arranged so that loads applied to the wire rods are transferred to the tube. In this embodiment, the wire rod ends which extend through the openings are bent back around the tube to be used as an anchorage for the seat back tether connection.

In a still further embodiment of the present invention a generally U-shaped strap surrounds a portion of a tube and the wire rod is formed to pass through opposed ends of the strap so that portions of each leg of the wire rod lies against an outer surface of the tube. The assembly may be located at any position along the tube and is spot welded at the desired final location.

In yet another embodiment, the wire rods are bent into a Z shape (the rods still having a U-shaped coupling portion and a pair of legs extending therefrom). These wires are inserted through a carrier bracket such that loads imposed thereon are transferred to the bracket, which in the illustrated embodiment is coupled to a tube frame.

How the foregoing and other features of the present invention are accomplished individually, collectively or in various sub-combinations will be described in the following detailed description of the preferred and alternate embodiments taken in conjunction with the attached FIGURES.

Other ways in which the above-referenced features are accomplished will become apparent to those skilled in the art after they have read this specification, and such other ways are deemed by the inventors to fall within the scope of the present invention if they fall within the scope of the claims which follow.

### BRIEF DESCRIPTION OF THE DRAWINGS

In the FIGS. , like reference numerals will be used to designate like components, wherein:

FIG. 1 is a front perspective view of a tube having a wire rod inserted there through according to a first preferred embodiment of the present invention;

FIG. 2 is a schematic sectional view of the combination shown in FIG. 1;

FIG. 3 is a schematic sectional view of a modification of the embodiment shown in FIG. 1, wherein the wire rod is mechanically coupled to a single wall of the tube;

FIG. 4 is a perspective view of a bracket and wire rod system according to a second preferred embodiment of the present invention showing the curled ends of the wire rod;

FIG. 5 is a perspective view of a combination seat anchorage and tether anchorage system according to a third preferred embodiment of the present invention;

FIG. 6 is an end schematic view showing the seat anchorage and tether anchorage of the third embodiment of the present invention of FIG. 5;

FIG. 7 is a side view of a fourth embodiment of the present invention showing a Z-shaped bend for the wire rod and a carrier bracket;

FIG. 8 is a perspective view of the fourth embodiment shown in FIG. 7 and further showing components of a vehicle seat frame;

FIG. 9 is a perspective view of a further preferred embodiment of the present invention showing a wire rod and a strap component for connection to a tube;

FIG. 10 is an end view of the embodiment of FIG. 9 positioned on a tube; and

FIG. 11 is an isolated perspective view of the strap component of the assembly of FIG. 9.

### DETAILED DESCRIPTION OF THE PREFERRED EMBODIMENTS

Initially provided are several general comments about the applicability and scope of the present invention. First, the materials used for the wire rods and other structural components shown in the FIGURES can be selected from those known to the art, including steel, various other alloys, or high strength metals such as stainless steel and steel alloys. In particular, the wire rod is preferably made of steel consistent with ASTM A510 standard, steel grade 1018 which is reduction hardened to have a minimum yield strength of at least 80 k.s.i. using any known or appropriate manufacturing process or what may be mandated by other regulation or standard.

Second, the number of anchorages will vary with the type of vehicle, application and seat design. The spacing between a pair of anchorages remains substantially constant according to standards and regulations but may be of any known or appropriate distance. There will typically be a single pair of anchorage for a given passenger seat. Thus, for a bench seat having multiple passenger seats, two or three pairs of seat anchorage may be included. Further, it should be noted that the particular syntax and usage of the term anchorage herein is intended to be interpreted as appropriately applicable to either a given passenger seat and a given child safety seat or a plurality of same regardless of the correct grammatical context.

Third, the mechanical attachment feature of the present invention is primarily illustrated in connection with seat bite line anchorages. It is understood that any anchorage for a vehicle seat, including a tether anchorage, can also benefit from the teachings set forth herein.

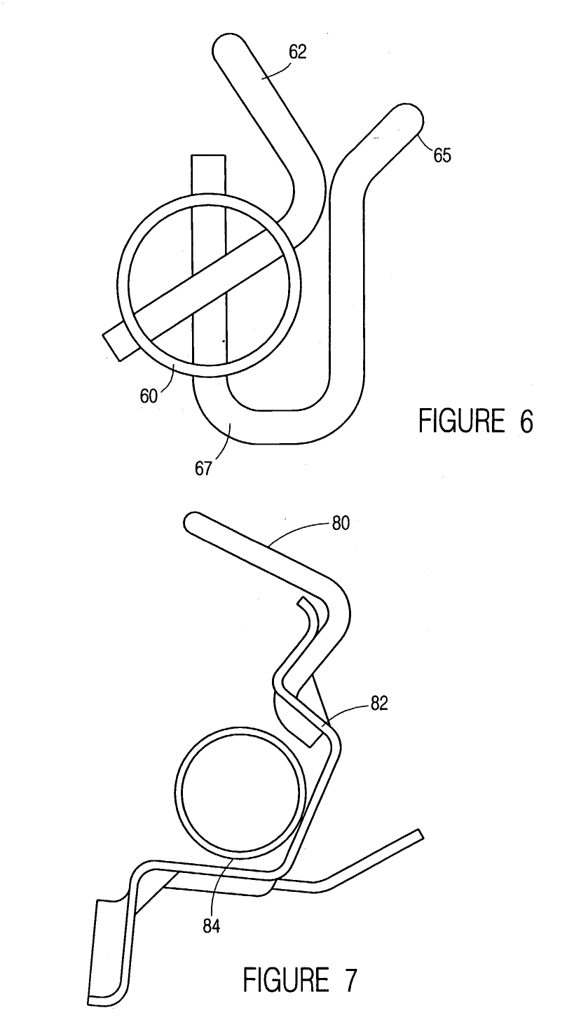

One example of a tether anchorage is provided in FIGS. 6 and 7 with the tether anchorage mechanically attached to the same tube as the child safety seat anchorages. However, the tether anchorage could be mechanically attached at other locations near the floor or on the rear of a seat back if suitable structural members are present there, and the tether anchorage could also be mechanically attached to a structural element at or beneath a package shelf, if any.

Fourth, the child safety seat anchorages are illustrated for use with passenger vehicles, such as automobiles, light trucks, SUVs, vans and the like. However, the principles of the present invention are readily adaptable to install anchorages at other locations with in a particular vehicle as well in any appropriate application including such as in airplanes, trains, buses and even in strollers with detachable seats.

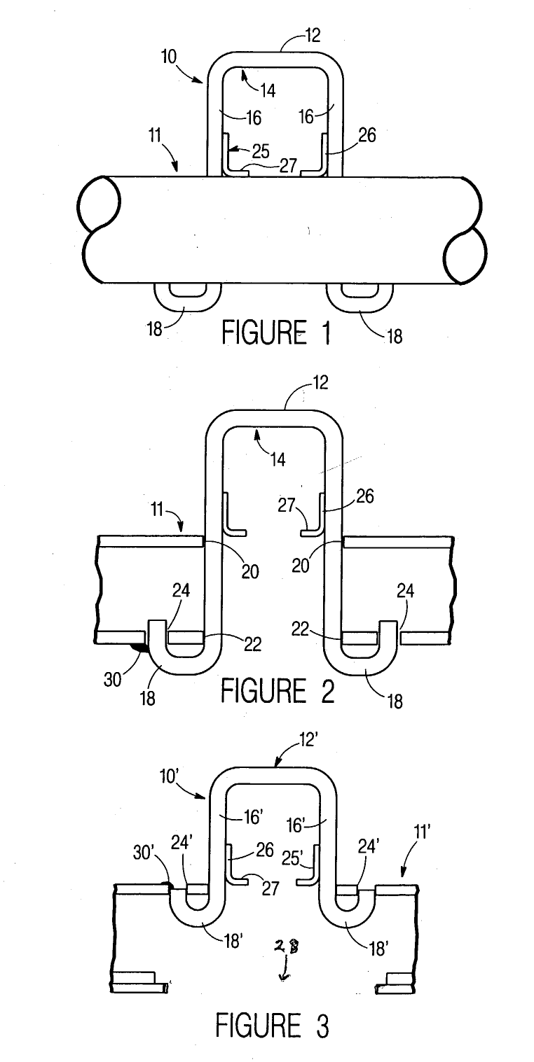

Proceeding now to the description of FIGS. 1-2, a anchorage system 10 is shown in a first preferred embodiment depicted in perspective and sectional views. The anchorage system 10 includes a generally U-shaped wire rod 12 adapted to be inserted into and mechanically attached to a tube 11. Wire rod 12 is depicted as having a round or circular cross-section. It should be understood that the wire rod 12 may have any appropriate or known shape cross-section without departing from the broader aspects of the present invention. The wire rod 12 includes a generally U-shaped end 14 and a pair of elongate legs 16. The U-shaped end 14 is preferably constructed to receive car seat connections or hooks (not shown). The elongate legs 16 are long enough to allow placement of end 14 at the correct location in the vehicle and to extend through tube 11 by a sufficient amount to allow curled ends 18 to bend about the outside of tube 11 and reenter the tube 11 through a pair of openings 24.

To this end, tube 11 includes a pair of slots 20 and 22, each wide enough to allow the rod material to pass through the tube and long enough to spread between legs 1 6. Installation can easily be comprehended from FIG. 2 where the wire rod is pushed upwardly through slot 22 until portion 14 passes through slot 20. If properly prepared, U-shaped end 14 will be precisely located when wire rod 12 is full inserted into the tube 11 so that ends 18 pass into holes 24.

With respect to FIGS. 1 and 2, it may be appreciated that wire rod 12 can be held in position using a friction or interference fit, if close tolerances are followed, or the wire rods 12 can be prepared so that the legs 16 diverge slightly so that wire rod 12 will be held in tube 11 by an outwardly directed spring force acting on the ends of slots 20 and 22. The easiest way to ensure that wire rod 12 will hot move with respect to tube 11 is to spot weld any area of the wire rod 12 to tube 11, as is illustrated at 30 in FIG. 2.

Collars 25 are also shown in FIGS. 1-3 having a semi-cylindrical leg 26 partially surrounding legs 16 and a perpendicular leg 27. Collars 25 are welded to tube 11 and assist in preventing bending of legs 16 under load conditions.

Referring next to FIG. 3, an alternate embodiment is shown which relies on some of the teachings of the FIG. 1 embodiment, and some of the same reference numbers with a prime notation used to indicate components. Legs 16′ are shorter, and holes 24′ are located on the same side of the tube 11 as slot 20′. Fabrication here is accomplished by urging wire rod 12′ through a longer slot 28 until the legs 16′ are received in holes 24′. Spot welding as at 30′, the addition of a second bracket to close out slot 28, and the addition of collars 25′ completes the fabrication.

It can now be appreciated that both embodiments described to this point rely on mechanical attachment of the wire rods to the main load carrying component (i.e., the tube 11), and that while spot welds may be provided to hold the wire rods in place, impact or deceleration loads are transferred directly to the load carrying component without relying on the strength or the size of the weld or the workmanship thereof.

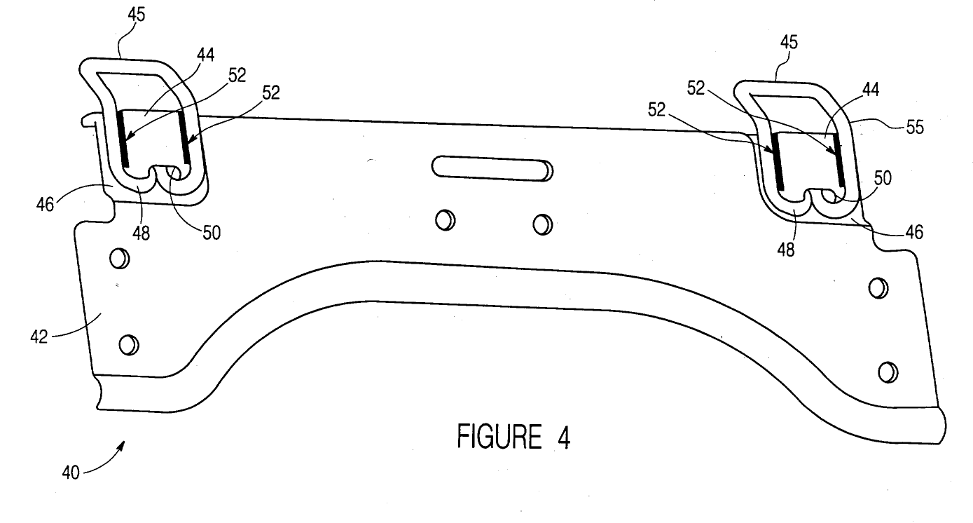

The second preferred embodiment of the present invention is illustrated in FIG. 4 where a bracket and wire rod assembly 40 is shown from a rear view. The bracket 42 may be made from any suitable, strong material useful for manufacturing seating components and is stamped or otherwise formed in the shape shown. In this embodiment, a pair of raised surfaces are formed in bracket 42, and a pair of wire rods 45 are connected to the bracket around the raised areas.

A depressed region or channel 46 is formed around the two sides and the bottom of each raised portion 44, the raised portion being sufficiently high from the bottom of the channel to accommodate the thickness of the wire rods 45.

Alternatively to the other embodiments, in the present design, the ends of the legs of the wire rods 45 are curled inwardly at 48, and a slot opening 50 is provided at the lower junction of the raised portion 44 and channel 46. The slot is sufficiently wide to allow the insertion of the ends of both inwardly curled legs 48.

After the wire rods 45 are in such position, they may be attached to bracket 42 by means of welds shown at 52. In this instance the welds 52 are preferably edge welds opposed to the spot welds shown on other embodiments. These welds 52 will retain the wire rods 45 in the appropriate position relative to the seat, but it will be understood by reference to the overall drawings that loads imposed on wire rods 45 will be efficiently transferred to the bracket 42.

It should also be noted in FIG. 4 that the wire rods are bent forwardly as at 55, the amount of which will depend on the seat frame design, location and the overall size of the wire rods 45. In any event, when the bracket 42 is suitably welded, bolted or otherwise attached to the seat frame or frame of the vehicle, another mechanical attachment system for the wire rods has been illustrated.

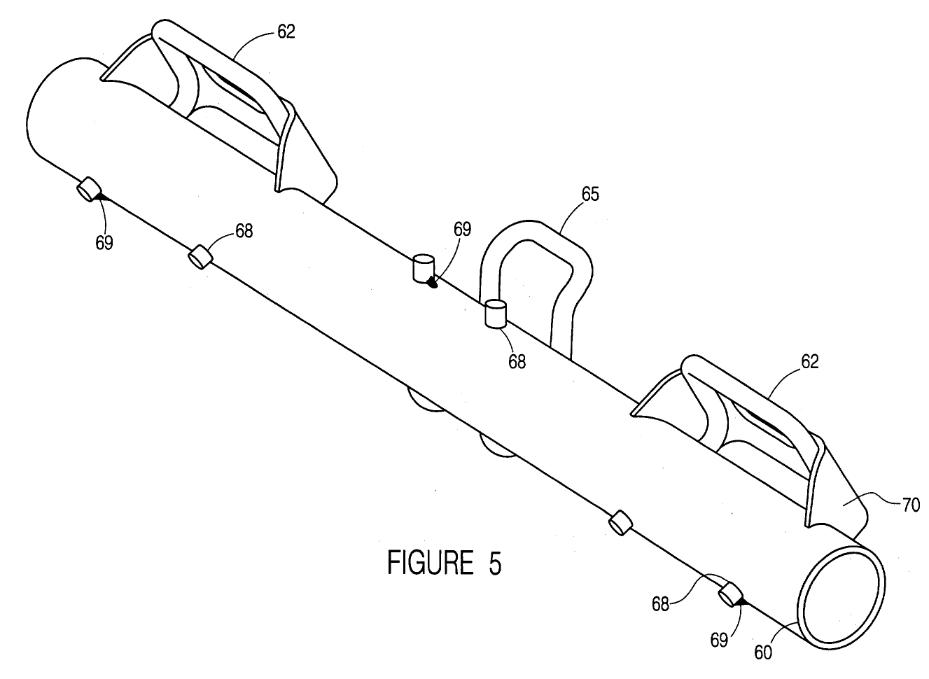

FIG. 5 illustrates in a front perspective view of a third preferred embodiment of the invention, this one including a tether anchorage along with the seat connector anchorages previously discussed. This embodiment includes a tube 60 which extends along and beneath the rear of the seat cushion so that a pair of wire rods 62 may be fastened thereto to provide the required seat anchorages. Located in between wire rods 62 is another wire rod 65 which extends through tube 60 and is bent around the tube so that a tether hook extending from a car seat (not shown) can be secured thereto by passing the tether strap over the back of the seat and coupling a hook or other fastener to wire rod 65 at or near the floor of the vehicle.

The construction of the embodiment of FIG. 5 is simple in that the wire rods 62, 65 are formed with the necessary bends, as at 67, and a straight portion passes through diametrically opposed openings 68 in the tube. A spot weld such as at 69 may be used to retain the wire rods in their appropriate position.

The geometry of the rods 62 and 65 is shown in an end view schematic at FIG. 6. From this illustration, it will appear to those skilled in the art that loads extending longitudinally from the U-shaped ends will be directly transferred to the support tube. Tube 60 may be attached to the vehicle seat, to the vehicle or at some other location suitable for absorbing impact and rapid deceleration forces.

As shown in FIGS. 5 and 6, a respective bracket element 70 surrounds at least an intermediate portion of each of the wire rods 62 and acts, as with the channel brackets of FIG. 1, to resist bending of the wire rod 62. The particular shape and the method of attachment of the bracket elements 70 is not critical to the present invention provided the bracket element 70 support and co-act with at least a portion of the wire rod 62.

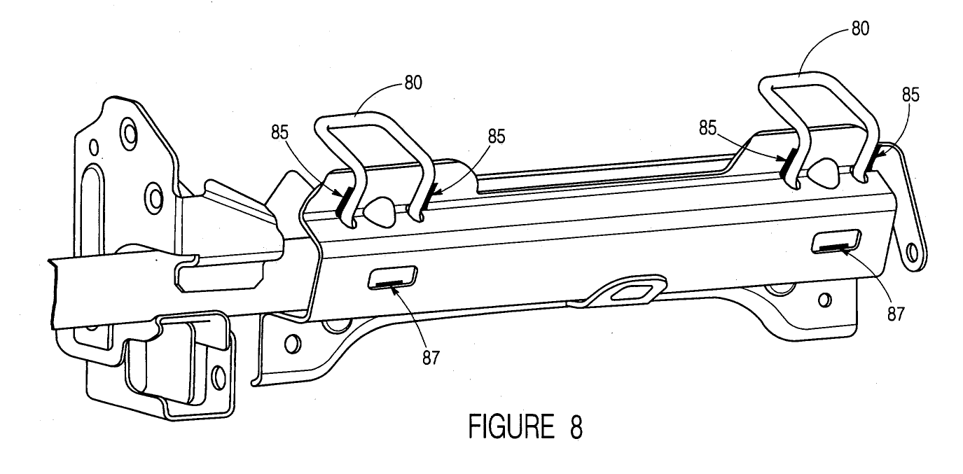

Another embodiment of the invention is shown in FIGS. 7 and 8. In this embodiment, probably best appreciated by reference to the side schematic of FIG. 7, the wire rod 80 is bent into a generally Z-shape and extends through openings in a carrier bracket 82 which in turn is securely attached to a tube 84. A rear isometric view of this embodiment is shown in FIG. 8 with several automotive seat vehicle components illustrated (but not described), showing the exposed portion of rods 80. Rods 80 may be welded as indicated at 85, while the retaining bracket 82 is welded to tube 84 as shown at 87. Again, while welds are employed to hold the wire brackets 80 in place, loads imparted thereto are transferred directly to the retaining bracket and then to the tube, with the welds playing only an insubstantial role in the overall strength of the wire rod connection.

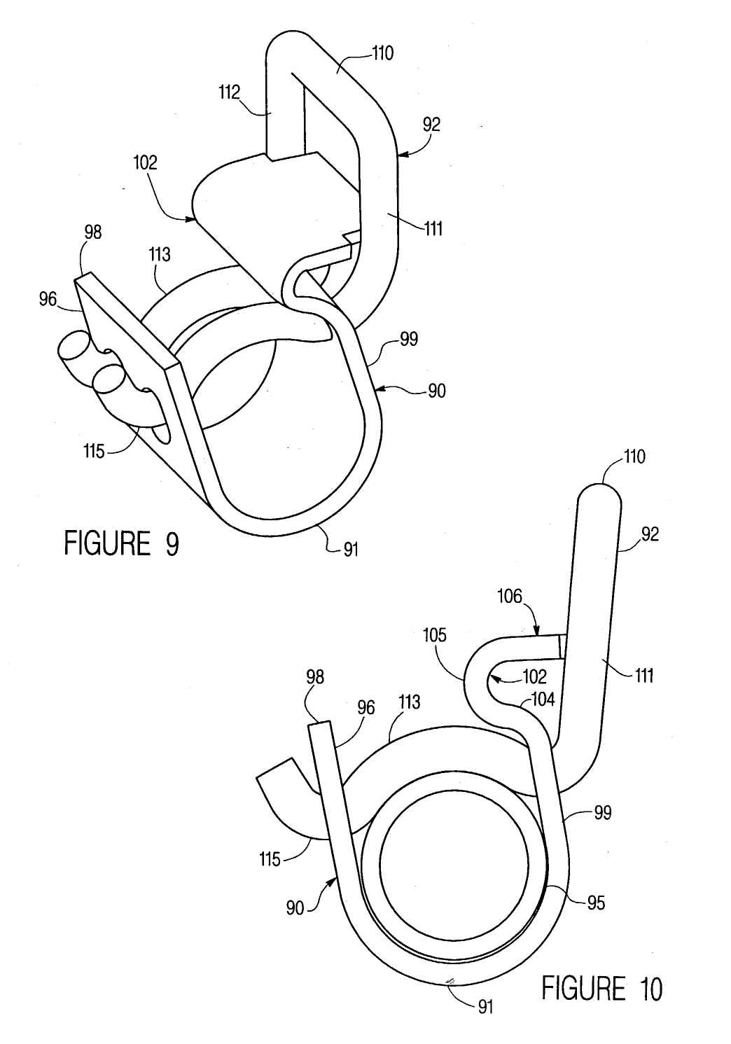

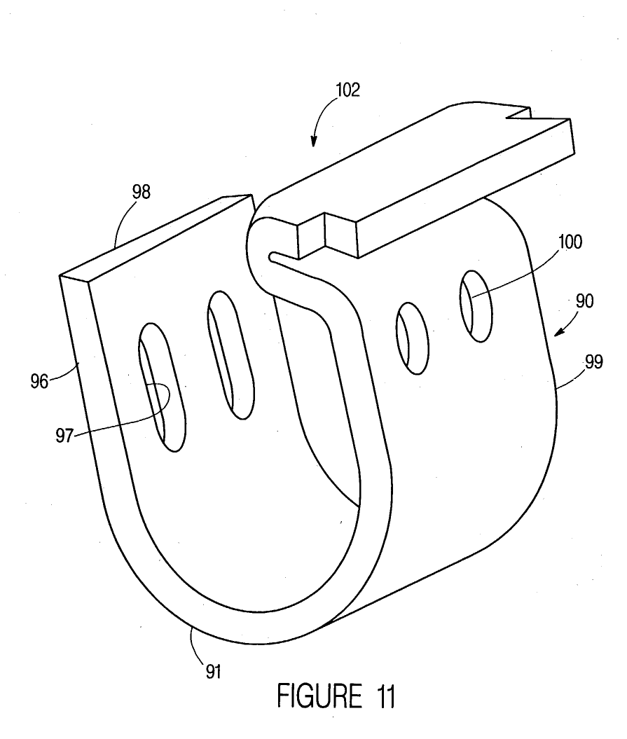

A still further embodiment of the present invention is illustrated in connection with FIGS. 9-11. In this embodiment, the mechanical coupling is accomplished using a strap 90 and a wire rod 92 adapted to engage one another and generally surround a fixed tube 95 (see FIG. 10). The strap 90 is general U-shaped and includes a first leg 96 having a pair of generally parallel slots 97 between the bottom 91 of the “U” and the top 98 of leg 96. The other leg includes a pair of holes 100 located between the bottom 91 of the “U” and a bend 102 located at the top of leg 99. The bend 102 includes an inwardly directed portion 104, a 180° U-shaped bend portion 105 and a top portion 106.

The wire rod 92, best seen in FIG. 9, is also generally U-shaped and includes the attachment portion 110 (for attachment of a car seat strap, etc.), and a pan of legs 111 and 112. The legs 111 and 112 are configured to pass through holes 100, extend over a tube in a generally curved middle section 113 and terminate in bent sections 115 (about 90°) after they have passed through slots 97.

As can be appreciated from FIGS. 9-10, the strap 90 and wire rod 92 will preferably be pre-assembled and then installed on and moved along tube 95 to the desired location where the strap 90 and the wire rod 92 may be affixed in any suitable manner, e.g., spot welding, staking, or the like. As with the other embodiments, forces imparted to attachment portion 110 are transferred mechanically to the tube 95. While the strap 90 does support the wire rod 92 and does carry a portion of the load applied to the wire rod 92, necessarily a portion of the load applied to the wire rod 92 will pass through the weld between the wire rod 92 and the tube 95

While several embodiments of the invention have been described in connection with the illustrations, and various modifications thereto have been referred to in the written text, the invention is the mechanical attachment of the wire rods to various support structures, and the shift away from using welds as the primary mechanism by which loads are imparted to the supports. Accordingly, the invention may be variously embodied using this basic principle without departing from its intended scope. The invention is therefore not to be limited to the materials, shapes, orientations and proportions illustrated and described, but it is to be limited solely by the scope of the claims which follow.

What is claimed is:

1. An anchorage for receiving a connector of an article to be secured in a vehicle, the anchorage comprising:
a vehicle having a seat having a bite line;
a structural element attached to one of the seat or to the vehicle and located with respect to the seat bite line;
at least one wire rod mechanically coupled to the structural element so that an anchorage portion of the at least one wire rod is located in the vicinity of the seat bite line, the rod and structural element being arranged so that a substantial portion of any load applied to the anchorage portion is transferred directly to the structural element.

2. The anchorage of claim 1, wherein the at least one wire rod is also welded to the structural element to ensure proper positioning of the at least one wire rod.

3. The anchorage of claim 1, wherein the structural element is a tube.

4. The anchorage of claim 3, wherein the at least one wire rod is generally U-shaped and includes a pair of legs joined to the anchorage portion, the legs being mechanically coupled to the tube.

5. The anchorage of claim 4, wherein each leg includes an end remote from the anchorage portion, each end of each leg being curled outwardly with respect to the area defined by the legs and the anchorage portion.

6. The anchorage of claim 5, wherein the tube includes a pair of longitudinal and opposed slots sized to receive the anchorage portion and the legs of the wire rod there through, a pair of holes being provided at spaced apart, linearly disposed locations with respect to one of the slots and arranged to receive the curled ends of the wire rod when the wire rod is fully inserted through both slots.

7. The anchorage of claim 5, wherein the tube includes a longitudinal slot sized to receive the anchorage portion and the legs of the rod there through, a pair of holes being provided at spaced apart, linearly disposed locations with respect to the slot and arranged to receive the curled ends of the wire rod when the wire rod is received in the slot.

8. The anchorage of claim 7, wherein the one slot is longer than the other to permit the wire rod and the curled ends thereof to pass there through, the holes being located and spaced apart from the shorter of the two slots.

9. The anchorage of claim 7, wherein the tube is a cylindrical tube.

10. The anchorage of claim 9, wherein the at least one wire rod comprises two wire rods mechanically coupled to the tube.

11. The anchorage of claim 8, wherein the tube is a cylindrical tube.

12. The anchorage of claim 11, wherein the at least one wire rod comprises two wire rods mechanically coupled to the tube.

13. The anchorage of claim 4, wherein the legs are bent at an obtuse angle and remain parallel to one another, the legs thereby each having a first portion generally coplanar with the anchorage portion and a second portion angled with respect to such plane.

14. The anchorage of claim 13, wherein the tube includes two pairs of aligned openings arranged to receive the second portions of the wire rod there through to provide the mechanical coupling.

15. The anchorage of claim 14, wherein the tube is a cylindrical tube.

16. The anchorage of claim 15, wherein the at least one wire rod comprises two wire rods mechanically coupled to the tube.

17. The anchorage of claim 14, wherein the at least one wire rod comprises two wire rods mechanically coupled to the tube, and the anchorage further comprises a tether strap anchorage coupled to the tube between the pairs of rods.

18. The anchorage of claim 17, wherein the tether strap anchorage is a wire rod including an anchorage portion and a pair of U-shaped legs integrally formed therewith, the tube including a further pair of aligned holes and the legs of the tether strap anchorage passing there through to mechanically attach the tether strap anchorage to the tube.

19. The anchorage of claim 1, wherein the structural element is a bracket.

20. The anchorage of claim 19, wherein the bracket includes two channels extending from an edge and defining a pair of raised portions in located with respect to the bite line and wherein the at least one wire rod has a U-shape including an anchorage portion and a pair of legs extending generally perpendicular therefrom, the legs being mechanically coupled to the bracket.

21. The anchorage of claim 20, wherein the ends of the legs are curled inwardly into the space defined by the connector portion and the legs, the raised portion including an opening to receive the curled legs, whereby the anchorage portion extends substantially beyond the edge of the bracket for being located with, respect to the bite line and loads applied to the connector portion are substantially transferred to the bracket.

22. The anchorage of claim 21, wherein the at least one wire rod is also welded to the bracket to ensure proper location of the at least one wire rod with respect to the bite line.

23. The anchorage of claim 20, wherein the at least one wire rod comprises two wire rods provided for a single bracket.

24. The anchorage of claim 23, wherein the bracket is secured to an additional structural element for added robustness.

25. The anchorage of claim 3, wherein the structural member includes a retaining bracket having a slot there through for the at least one wire rod to be attached thereto, the retaining bracket being arranged to have a right angle bend parallel to the seat, the wire rod having an attachment portion and a pair of parallel legs extending therefrom, the legs being bent twice into Z-shaped portions, the legs being passed through the slot and the rod being in engagement with the right angle bend of the bracket and the anchorage portion of the rod extending beyond the bracket for being located at a selected location relative to the seat bite line.

26. The anchorage of claim 24, wherein the wire rod is welded to the retaining bracket.

27. The anchorage of claim 24, wherein at least two pairs of wire rods are mechanically coupled to each bracket.

28. The anchorage of claim 24, wherein the retaining bracket is welded to another structural element.

29. The anchorage of claim 3, further comprising a strap partially surrounding the tube and wherein the at least one wire rod extends through the strap to mechanically couple the anchorage portion of the at least one wire rod to the tube.

30. The anchorage of claim 29, wherein the strap includes a bottom conforming to the curvature of the tube, and first and second legs extending from the bottom and being generally parallel to one another.

31. The anchorage of claim 29, wherein the wire rod includes a pair of legs, the first leg of the strap includes a pair of holes and the second leg of the strap includes a pair of slots, each leg of the wire rod extending. through a hole and a slot of the strap.

32. The anchorage of claim 31, wherein each leg of the wire rod includes a portion located between the holes and slots of the strap, the portion being curved to generally conform to the curvature of the tube at a location of the tube separate from the bottom of the strap.

33. In combination, a structural support having at least one wire rod anchorage mechanically coupled thereto, without fasteners or welds providing significant load transfer capabilities, the mechanical coupling means providing the primary means for transferring loads imposed on a rod to the structural member.

34. The combination of claim 33, wherein the structural support is a tube and the wire rod is generally U-shaped and is configured to be coupled to at least one side wall of the tube.

35. The combination of claim 33, wherein the structural support is a tube and the wire rod is generally U-shaped as is configured to extend through opposed openings in the tube.

36. The combination of claim 33, wherein the structural support is a bracket plate having at least one raised portion having an opening therein, the wire rod extending about the raised portion and having curled portions- of the rod extending into the opening.

37. The combination of claim 33, wherein the structural support includes a slot and a wall, and the wire rod is bent and extends through the slot and against the wall.

38. A method for mechanically coupling a wire rod anchorage to a support consisting essentially of coupling an engaging portion of the wire rod with a receptor portion in the support, whereby loads imposed on the wire rod anchorage are transferred to the support.

39. The method of claim 38 comprising the additional step of spot welding the wire rod to the bracket to properly locate the wire rod with respect thereto.

40. The method of claim 38, wherein the support comprises a tube and a strap partially surrounding the tube, wherein the wire rod extends through the strap.

41. The method of claim 40, wherein the strap is generally “U” shaped and includes holes in one leg and slots in the other leg, the wire rod including legs each of which extends through both a hole and a slot.
